(19) United States
(12) Patent Application Publication
(10) Pub. No.: US 2008/0016093 A1
(43) Pub. Date: Jan. 17, 2008

(54) APPARATUS, SYSTEM, AND METHOD FOR SUBTRACTION OF TAXONOMIC ELEMENTS

(76) Inventor: Clement Lambert Dickey, San Jose, CA (US)

Correspondence Address: Kunzler & McKenzie, 8 EAST BROADWAY, SUITE 600, SALT LAKE CITY, UT, 84111, US

(21) Appl. No.: 11/456,646

(22) Filed: Jul. 11, 2006

(51) Int. Cl. G06F 7/00

(52) U.S. Cl. 707/101

(57) ABSTRACT

An apparatus, system, and method are disclosed to categorize objects of a selected taxonomy having a known relationship. The apparatus includes an identification module, a subtraction module, a minimization module, and a listing module. The identification module identifies specific sets of objects from within the taxonomy. The subtraction module subtracts a second set of objects from a first set of objects. The first set of objects may have a known positive relationship, and the second set of objects may have a known negative relationship. The minimization module removes a child object from a set when a parent object of the child object is also a member of the set. The listing module creates a list of objects that are members of a specific set and stores the list of objects.

### BACKGROUND OF THE INVENTION

1. Field of the Invention

This invention relates to data classification and more particularly relates to data classification using hierarchical taxonomies.

2. Description of the Related Art

A hierarchical taxonomy is a tree structure used to classify any specific type of objects. The root object, or root node, is a single classification that applies to all nodes appearing below it in the tree. Each node below the root node in the tree structure represents a more specific classification that is a subtype of the root classification. This means that each node's classification or type applies to every descendant of that node. Descendants of a given node are the nodes that are both connected to the given node and are below the given node in the tree. Leaf nodes, or nodes that have no descendants, represent the most specific classifications that are found in the taxonomy. Because of this hierarchical method of classification, each child parent relationship in the tree is an “is a” relationship, meaning that each child object is a more specific subtype of its parent node or nodes, and that it is also a subtype of each of its ancestor nodes.

Nearly anything can be classified according to a taxonomic scheme. Taxonomies are often used to explore the relationships between a separate object or a separate taxonomy and the objects within a taxonomy. For example, all automobiles compatible with a specific oil filter may be selected from a taxonomy of automobiles. Such a relationship is usually described by a series of positive and negative statements. The oil filter may be compatible with all automobiles of make A except for model A1. It is often desirable to create a list containing only objects having positive relationships, with no negative relationships represented. In the automobile example, this would be a list of automobiles that the oil filter is compatible with. A list of objects having positive relationships may be useful when it is more convenient for a customer to have a list of only compatible products, or when a study is being performed on all animals having a certain trait. It is also much simpler to store and to manipulate a single list of objects having positive relationships in a computer database than it is to use separate lists of positive and negative relationships. Because objects in a taxonomy may represent any of their descendants, it is also desirable to have a minimal list of objects. A list or set is minimal if no object in the list can represent any other objects in the list.

From the foregoing discussion, it should be apparent that a need exists for an apparatus, system, and method that represents a relationship between objects in a strictly positive manner given an initial description of the relationship in a positive and a negative manner. Beneficially, such an apparatus, system, and method would facilitate the creation of a minimal list of all objects from a given taxonomy having a positive relationship with a separate object or taxonomy.

### SUMMARY OF THE INVENTION

The present invention has been developed in response to the present state of the art, and in particular, in response to the problems and needs in the art that have not yet been fully solved by currently available taxonomic manipulation methods. Accordingly, the present invention has been developed to provide an apparatus, system, and method for the subtraction of taxonomic elements that overcomes many or all of the above-discussed shortcomings in the art.

The apparatus to subtract taxonomic elements is provided with a plurality of modules configured to functionally execute the necessary steps of identifying sets of objects within a taxonomy, subtracting a second set of objects from a first set of objects, minimizing a the resulting set of objects, and listing the minimized set of objects. These modules in the described embodiments include an identification module, a subtraction module, a minimization module, and a listing module.

The identification module, in one embodiment, is configured to identify a set of objects within the taxonomy. In one embodiment the identified set includes one or more objects and all descendants of the objects. In another embodiment the set includes one or more objects, all ancestors of the objects, and all descendants of the objects.

The subtraction module, in one embodiment, is configured to subtract a second set of objects from a first set of objects. In one embodiment the first set of objects has a known positive relationship, and the second set of objects has a known negative relationship.

The minimization module, in one embodiment, is configured to minimize a set of objects. In another embodiment, the minimization comprises removing a child object from a set when a parent object of the child object is also a member of the set.

The listing module, in one embodiment, is configured to create a list of objects. In another embodiment, the listing module is configured to create a list of objects that are members of a specific set and to store the list of objects in a data storage device.

A computer readable medium is also presented to store a program that, when executed, performs operations to subtract taxonomic elements. In one embodiment, the operations include identifying a first and a second set of objects from within a taxonomy, subtracting the second set of objects from the first set of objects to create a third set of objects, removing all child objects from the third set of objects when a parent object of the child object is also a member of the third set, listing all objects that are members of the third set, and storing the list in a data storage device.

In one embodiment the first set includes one or more objects and all descendants of the objects. In a further embodiment, the second set includes one or more objects, all ancestors of the objects, and all descendants of the objects. In another embodiment the first set of objects has a known positive relationship, and the second set has a known negative relationship. In one embodiment the taxonomy has a known compatibility relationship with a separate object or taxonomy. In another embodiment the taxonomy represents computer components. The computer components may also comprise one or more computer operating systems, or any other computer hardware or software.

A method of the present invention is also presented for developing a list of compatible components for a client. The method in the disclosed embodiments substantially includes the steps necessary to carry out the functions presented above with respect to the operation of the described apparatus and system. In one embodiment, the components are computer components.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for subtraction of taxonomic elements in accordance with the present invention;

FIG. 2 is a schematic block diagram illustrating one embodiment of a listing apparatus in accordance with the present invention;

FIG. 3 is a schematic flow chart diagram illustrating one embodiment of a taxonomic element subtraction method in accordance with the present invention; and

FIG. 4 is a block diagram illustrating one embodiment of an identification method in accordance with the present invention.

FIG. 5 is a block diagram illustrating another embodiment of an identification method, a subtraction method, and a minimization method in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer readable medium may take any form capable of generating a signal, causing a signal to be generated, or causing execution of a program of machine-readable instructions on a digital processing apparatus. A computer readable medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

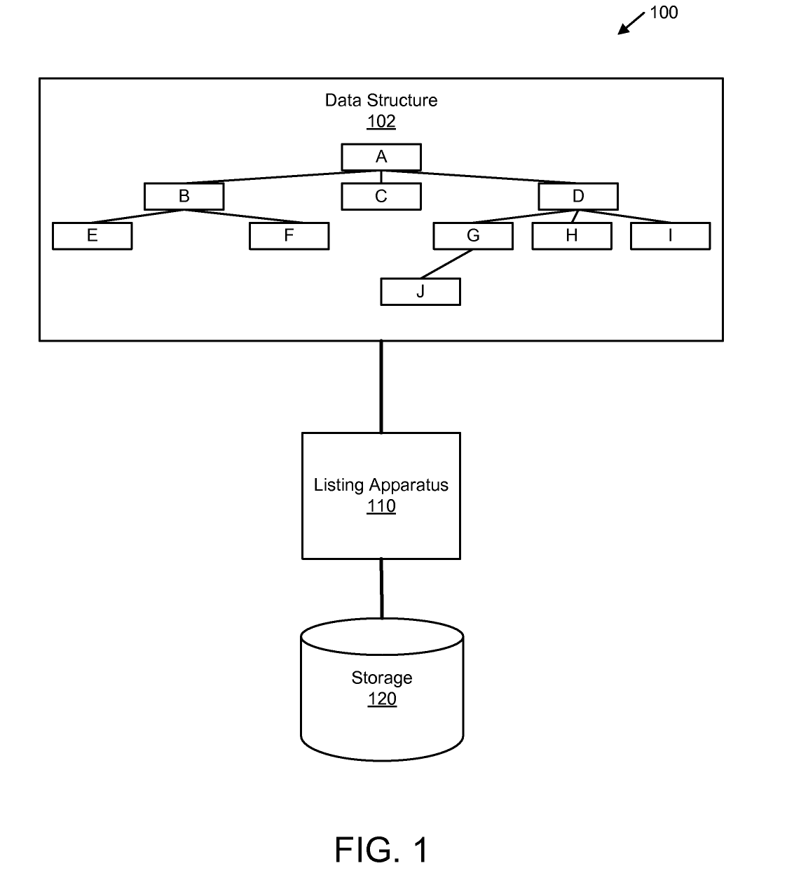

FIG. 1 depicts one embodiment of a taxonomic element subtraction system 100. The illustrated taxonomic element subtraction system 100 includes a taxonomic data structure 102. The data structure 102 includes a plurality of data objects labeled A, B, C, D, E, F, G, H, I and J. The depicted data objects A through J are representative of any type of data object, including strings, trees, tables, lists, files, directories, and so forth, that may be included in the taxonomic data structure 102. Each string, tree, table, list, file, directory, or other data object represented by data objects A through J may further represent any object that can be represented in a taxonomy, including computer hardware or software components, mechanical parts, living organisms, commercial products, geographical regions, and so forth.

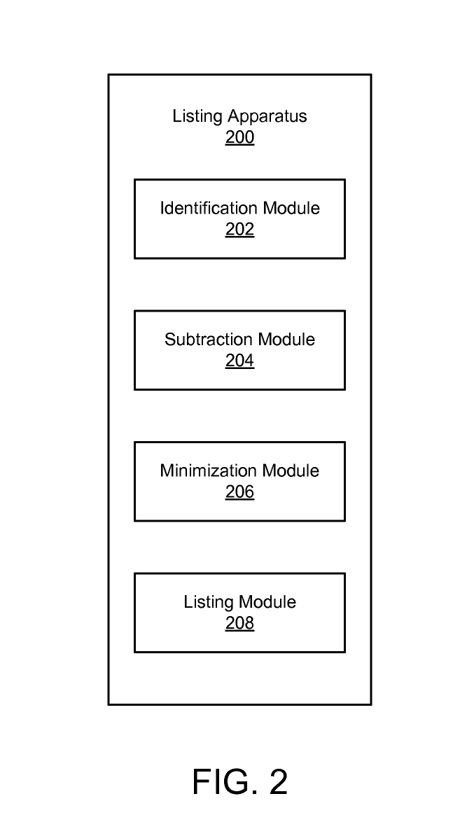

The illustrated taxonomic element subtraction system 100 also includes a listing apparatus 110, and a data storage device 120. One example of the listing apparatus 110 is provided and described in more detail with reference to FIG. 2. In general, the listing apparatus 110 generates a minimal list of objects by subtracting one set of objects from another set of objects and minimizing the resulting set.

In one embodiment the listing apparatus 110 is coupled to the data storage 120 where it can create, access, store, and/or modify taxonomic data structures, lists of objects, and any other data. The data structure 102 may be stored in the data storage device 120, retrieved from the data storage device 120 and copied into separate storage, or retrieved and stored from one or more separate storage devices. A data storage device may be any type of data storage or memory device, including electrical, magnetic, or optical storage.

FIG. 2 depicts one embodiment of a listing apparatus 200 that may be substantially similar to the listing apparatus 110 of FIG. 1. As described above, in general the listing apparatus 200 generates a minimal list of objects by subtracting one set of objects from another set of objects and minimizing the resulting set. The illustrated listing apparatus 200 includes an identification module 202, a subtraction module 204, a minimization module 206, and a listing module 208.

In one embodiment, the identification module 202 identifies a set of objects from the data structure 102. Alternatively, the identification module 202 may identify two separate sets of objects from the data structure 102, a first set and a second set. The second set may be a subset of the first set, may include a subset of the first set, or may be disjoint from the first set.

In a further embodiment, the identification module 202 may identify a first set of objects by first identifying one or more objects, and then adding the objects and all descendants of the objects to the first set. The identification module 202 may identify the second set of objects by first identifying one or more objects, and then adding the objects, all ancestors of the objects, and all descendants of the objects to the second set. The second set may be a subset of the first set, may include a subset of the first set, or may be disjoint from the first set.

In one embodiment, the subtraction module 204 subtracts a second set of objects from a first set of objects. In a further embodiment, the first and second sets of objects are the first and second sets of objects identified by the identification module 202. In another embodiment the first set of objects has a known positive relationship with a separate object not included in the data structure 102, and the second set of objects has a known negative relationship with the same separate object.

In one embodiment, the minimization module 206 minimizes a set of objects. In another embodiment the minimization module 206 minimizes a set of objects by removing a child object from the set when a parent object of the child object is also a member of the set. In a further embodiment the minimization module 206 minimizes the set of objects created by the subtraction module 204.

In one embodiment, the listing module 208 creates a list of objects that are members of a specific set. The list may then be stored in the data storage device 120. The list may be stored for use by a database, word-processing, spreadsheet, or internet application, or for use by any other module or application.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

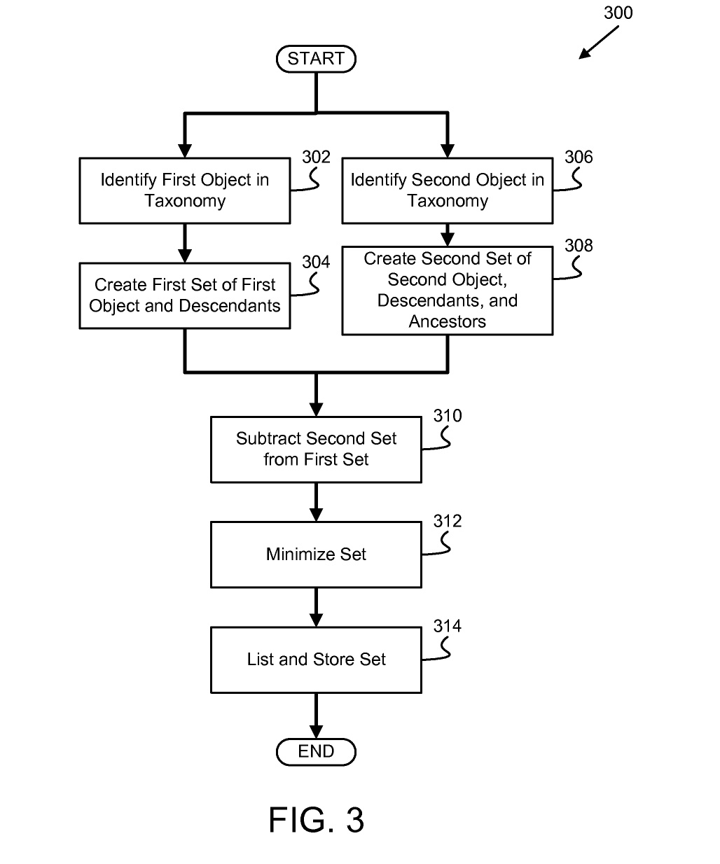

FIG. 3 is a schematic flow chart diagram depicting one embodiment of a subtraction method 300 that may be implemented on the taxonomic element subtraction system 100 of FIG. 1. Reference to the listing apparatus 200 is understood to alternatively refer to any other listing apparatus or corresponding listing operation described herein.

The identification module 202 identifies 302 a first object in the taxonomy 102. In one embodiment the first object has a known positive relationship with a separate object not necessarily included in the taxonomy 102. The identification module 202 creates 304 a first set, consisting of the first object and each descendant of the first object. The identification module 202 identifies 306 a second object from the taxonomy 102. In one embodiment the second object has a known negative relationship with the separate object not necessarily included in the taxonomy 102. The identification module 202 creates 308 a second set, consisting of the second object, each ancestor of the second object, and each descendant of the second object. In another embodiment, the first and second objects may be multiple objects with a similar relationship to the separate object not necessarily included in the taxonomy 102. In a further embodiment, steps 302 and 304 are performed in parallel with steps 306 and 308.

The subtraction module 204 subtracts 310 the second set from the first set to create a third set. If the first and second sets were disjoint, the third set will be identical to the first set. If the first and second sets were not disjoint, the third set will be a subset of the first set. In an embodiment where the first set has a known positive relationship with a separate object not necessarily included in the taxonomy 102, and the second set has a known negative relationship with the same object, the third set will also have a positive relationship with the separate object.

The minimization module 206 minimizes 312 the third set to create a minimal fourth set. In one embodiment the minimization comprises removing a child object from the set when a parent object of the child object is also a member of the set. In a taxonomy a parent may represent any of its descendants, so removing a child object from the set when a parent object of the child object is also a member of the set ensures that the set contains no objects that can be represented by any other object in the set.

The listing apparatus 200 then lists and stores 314 the minimal fourth set in the data storage device 120. The list contains all objects found in the fourth set. The objects may be listed in any order, and may be stored for use by a database, word-processing, spreadsheet, or internet application, or for use by any other module or application. In one embodiment the listing apparatus 200 employs the listing module 208 to list and store 314 the fourth set.

In an embodiment where the fourth set is a minimal set containing objects having a known positive relationship with a separate object not necessarily included in the taxonomy 102, the list will be a list of objects having a known positive relationship with the separate object. In an example embodiment where the objects represent computer components, or more specifically computer operating systems, and the separate object is another computer component, specifically a computer hardware component, and the known relationship is compatibility, the list that is listed and stored 314 by the listing module 208 would be a minimal list of computer operating systems compatible with the specific computer hardware component selected.

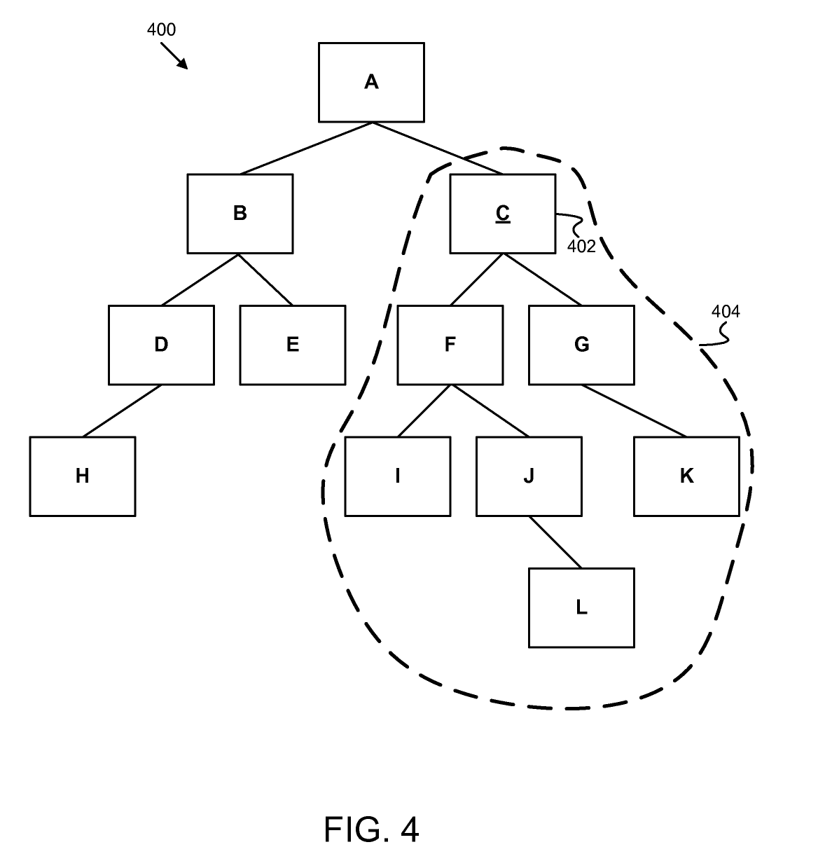

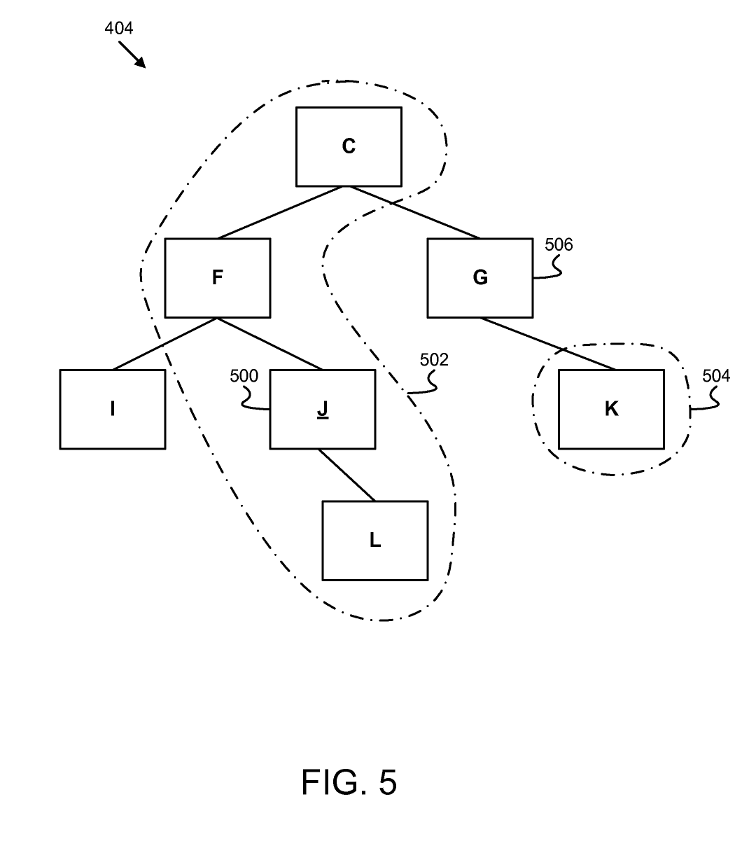

FIGS. 4 and 5 are block diagrams illustrating an exemplary embodiment of the methods found in FIG. 3. The data structure 400 is a hierarchical taxonomy similar to the data structure 102 from FIG. 1. The identification module 202 identifies 302 a first object C 402. The identification module 202 creates 304 a first set 404 containing object C 402 and all descendants of object C 402. The identification module 202 identifies 306 a second object J 500. The identification module 202 creates 308 a second set 502 containing object J 500, all ancestors of object J 500, and all descendants of object J 500. The subtraction module 204 subtracts 310 the second set 502 from the first set 404 to create a third set. The third set now contains objects G, I, and K. The minimization module 206 then minimizes 312 the third set, removing object K 504 because parent object G 506 of object K 504 is also a member of the third set. The listing module 208 lists and stores 314 the remaining objects, object G 506 and object I 508, for use by another module, apparatus, system or method.

Advantageously, certain embodiments of the apparatus, system, and method presented above may be implemented to simplify the creation of lists of objects having a known positive relationship with a separate object. Certain embodiments also may save additional processing, data access, and computation time when manipulating hierarchical taxonomies.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to categorize objects of a selected taxonomy having a known:
relationship, the apparatus comprising:
an identification module configured to identify one or more sets of objects within the taxonomy;
a subtraction module configured to subtract a second set of objects from a first set of objects; and
a minimization module configured to remove a child object from a set when a parent object of the child object is also a member of the set.

2. The apparatus of claim 1, further comprising a listing module configured to create a list of objects that are members of a specific set and to store the list of objects in a data storage device.

3. The apparatus of claim 1, wherein the first set of objects comprises one or more objects and all descendants of the objects.

4. The apparatus of claim 1, wherein the second set of objects comprises one or more objects, all ancestors of the objects, and all descendants of the objects.

5. The apparatus of claim 1, wherein the subtraction module is further configured to subtract a second set of objects having a known negative relationship from a first set of objects having a known positive relationship.

6. The apparatus of claim 1, wherein the known relationship is a known compatibility relationship between objects in the taxonomy and a separate object not in the taxonomy.

7. The apparatus of claim 1, wherein the selected taxonomy represents computer components.

8. A computer readable medium tangibly embodying a program of machine-readable instructions executable by a digital processing apparatus to perform an operation to categorize objects of a selected taxonomy having a known relationship, the operation comprising:
identifying a first set of objects within the taxonomy;
identifying a second set of objects within the taxonomy;
subtracting the second set of objects from the first set of objects to create a third set of objects; and
removing all child objects from the third set when a parent object of the child object is also a member of the third set.

9. The computer readable medium of claim 8, wherein the instructions further comprise an operation to list all objects that are members of the third set and to store the list of objects in a data storage device.

10. The computer readable medium of claim 8, wherein the first set of objects comprises one or more objects and all descendants of the objects.

11. The computer readable medium of claim 8, wherein the second set of objects comprises one or more objects, all ancestors of the objects, and all descendants of the objects.

12. The computer readable medium of claim 8, wherein the first set of objects has a known positive relationship.

13. The computer readable medium of claim 8, wherein the second set of objects has a known negative relationship.

14. The computer readable medium of claim 8, wherein the known relationship is compatibility.

15. The computer readable medium of claim 14, wherein the selected taxonomy represents computer components.

16. The computer readable medium of claim 15, wherein the computer components comprise one or more computer operating systems.

17. A computer implemented method for developing a list of compatible components for a client, the method comprising:
building a taxonomy of possible components;
identifying a first set of components from the taxonomy based on a positive compatibility;
identifying a second set of components from the taxonomy based on a negative compatibility;
subtracting the second set of components from the first set of components to create a third set of components; and
removing all child components from the third set of components when a parent component of the child component is also a member of the third set of components.

18. The computer implemented method of claim 17, wherein the first set of components comprises one or more components and all descendants of the components, and the second set of components comprises one or more components, all ancestors of the components, and all descendants of the components.

19. The computer implemented method of claim 17, wherein the method further comprises listing all components from the third set of components and storing the list in a data storage device.

20. The computer implemented method of claim 17, wherein the components are computer components.
